(19) United States
(12) Patent Application Publication
(10) Pub. No.: US 2020/0079631 A1
(43) Pub. Date: Mar. 12, 2020

(54) SIDE LIFT SPREADER FOR LIFTING INTERMODAL CONTAINERS, AND METHOD OF OPERATING A SIDE LIFT SPREADER

(71) Applicant: ELME SPREADER AB, Älmhult (SE)

(72) Inventors: Erik FÖRANDER, Virestad (SE); Örjan KARLSSON, Lund (SE)

(73) Assignee: ELME SPREADER AB, Älmhult (SE)

(21) Appl. No.: 16/498,673

(22) PCT Filed: Mar. 23, 2018
(86) PCT No.: PCT/SE2018/050309

§ 371 Date: Sep. 27, 2019

(30) Foreign Application Priority Data
Mar. 31, 2017 (SE) 1750402-8

(51) Int. Cl. B66F 9/18; B66C 1/22; B66F 9/075

(52) U.S. Cl. CPC B66F 9/186; B66F 9/0755; B66C 1/223

(57) ABSTRACT

A side lift spreader (20) for lifting an upper intermodal transport container (10′) and a lower intermodal transport container (10) stacked on each other comprises a container locking arrangement (30) arranged at a first longitudinal end of the spreader, the container locking arrangement (30) comprising an upper male lock insert configured to be connected to a bottom corner casting of the upper container (10′) and a lower male lock insert configured to be connected to a top corner casting of the lower container (10), wherein said container locking arrangement (30) comprises an indicator configured to provide an indication if an attempt is made to connect the lower male lock insert to the bottom corner casting of the upper container (10′).

### FIELD OF THE INVENTION

The present invention relates to a side lift spreader for lifting two intermodal transport containers. The invention also relates to a method of operating such a spreader.

### BACKGROUND OF THE INVENTION

An intermodal container is a standardized shipping container which can be used across and transferred between different modes of transport, such as rail, truck and ship, without unloading and reloading the cargo inside the container. Containers and other types of rigid load carriers of different standard dimensions are normally handled with the aid of a container spreader or yoke, which may typically be carried by a truck or a crane. The spreader attaches to a container at lifting castings, which are often called corner castings as they are typically arranged in all corners of a standard 20- or 40-foot container. For the purpose, the spreader is provided with a plurality of twist-locks or other container locking arrangements, which are known in the art. Often, the spreader is telescopic so as to allow changing the distance between container locking arrangements along a longitudinal axis of the container, in order to accommodate for containers of different standard lengths. Standards for intermodal containers are specified by the International Organization for Standardization, ISO, e.g. in the standards ISO 668:2013 and ISO 1496-1:2013.

Side lift spreaders are generally used for lifting empty containers, since due to the relatively low weight of an empty container, it may be sufficient to connect to the corner castings of a single lateral side of the container. Side lift spreaders may typically be carried by a lifting truck for moving the containers within e.g. a cargo terminal area. Sometimes, two empty containers may be transported at a time, with one container stacked on the other. An exemplary side lift spreader for simultaneously handling two containers is shown in EP 0701964.

Empty containers may be stacked on top of each other on rather high container stacks; in recent years, it has become common to use stacks of heights up to nine ISO containers, which corresponds to a stack height of about 22.5 metres. It is difficult for the operator of the truck to control the position of the container and/or the spreader at such high levels. Every day, containers are damaged during handling, and needless to say, a container dropped to the ground may cause substantial damage as well as danger to people. Hence, there is an incessant strive to increase the safety and reliability of container handling. At the same time, there are also other requirements that need to be met by a spreader. By way of example, it should be possible to produce and operate at a reasonable cost, and it should be easy and convenient to operate.

### SUMMARY OF THE INVENTION

It is an object of the present invention to solve, or at least mitigate, parts or all of the above-mentioned problems. To this end, there is provided a side lift spreader for lifting an upper intermodal transport container and a lower intermodal transport container in a single lifting operation, said upper and lower containers being stacked on each other, the spreader comprising a first container locking arrangement arranged at a first longitudinal end of the spreader, the first container locking arrangement comprising an upper male lock insert configured to be connected to a bottom corner casting of the upper container and a lower male lock insert configured to be connected to a top corner casting of the lower container, wherein said first container locking arrangement comprises an indicator configured to provide an indication if, or whether, an attempt is made to connect the lower male lock insert to the bottom corner casting of the upper container. In the event that an attempt is made to connect the lower male lock insert to the bottom corner casting of the upper container, there would simultaneously be an attempt to connect the upper male lock insert to a portion of the upper container above the level of the bottom corner casting of the upper container. If the container is a normal cargo container, this would typically result in the upper male lock insert making a dent in the cargo container door or wall before being blocked, and the truck operator realizing his/her mistake and trying again. However, if the cargo container is provided with a recess where the upper male lock insert attempts to enter, both male inserts may be moved to a position corresponding to a completed connection motion. In such a situation, the mistake may pass undiscovered, and the operator may attempt to try a lift. This would inevitably result in more severe damage to the container, and might even result in dropping the lower container, if the lift is somewhat successful initially. By way of example, refrigerated containers are sometimes provided with recessed doors, which may allow e.g. an upper side clamp to move freely in front of the door if a lower side clamp is connected to the bottom corner casting of the upper container.

According to an embodiment, said indicator may be configured to provide an indication if, or whether, an attempt is made to connect the lower male lock insert to the bottom corner casting of the upper container without the upper male lock insert engaging with the upper container.

According to an embodiment, said indicator may comprise a portion of the lower male lock insert geometrically shaped to prevent insertion of the lower male lock insert into the bottom corner casting of the upper container. Such an indicator is very simple and inexpensive, as it requires no extra parts to operate. Moreover, it is intrinsically very robust and unlikely to fail as long as the corner castings of the containers conform to the shapes specified in the established ISO standards; hence, according to an embodiment, said bottom corner casting may be a bottom corner casting pursuant to ISO 668:2013 and/or ISO 1396-1:2013. Obviously, the upper male lock insert may be geometrically shaped to allow insertion into the bottom corner casting of the upper container. According to an embodiment, said lower male lock insert may be adapted to be inserted into a gable lock opening of the top corner casting of the lower container, wherein said lower male lock insert has a horizontal width exceeding the horizontal width of a gable lock opening of the bottom corner casting of the upper container. The standardized, differing widths of the upper and lower gable lock openings thereby provide a simple and reliable means of distinguishing between an upper and a bottom corner casting. A gable lock opening of a bottom corner casting of an ISO container has a horizontal width of 51 mm; hence, the horizontal width of the lower male lock insert preferably exceeds 51 mm. More preferably, it exceeds 54 mm to provide some margin. The upper male lock insert may have a horizontal width of less than the horizontal width of the gable lock opening of the bottom corner casting of the upper container, i.e. of less than 51 mm, or less than 48 mm to provide some margin. There are however also other, alternative ways to distinguish between the ISO-standardized top and bottom corner castings, since they differ geometrically also in other aspects than the shapes and dimensions of the gable openings. For example, the longitudinal side lock opening of a bottom corner casting is located close to the top of the corner casting, whereas the longitudinal side lock opening of a top corner casting is located close to the bottom of the corner casting. Also this difference may be used for designing a male lock insert that is capable of engaging with one but not the other.

According to an embodiment, said lower male lock insert may be configured as a lower side clamp pivotal about a substantially vertical axis. Such a configuration may allow, in a simple manner, maintaining the lower side clamp retracted behind a plane defined by the longitudinal side of the container while positioning the spreader prior to connection. Thereby, the risk of damaging the lower male lock insert due to an impact between spreader and container, during positioning, is reduced. Moreover, it can be pivoted to a retracted position in which it is completely received in the spreader head. According to an embodiment, the upper male lock insert may be configured as an upper side clamp pivotal about said substantially vertical axis. Such a configuration may protect also the upper side clamp from impact. Each of the side clamps may have the general shape of a claw, wherein the lower male lock insert may be wider at the base than the upper male lock insert to prevent a complete insertion of the lower male lock insert into the bottom corner casting of the upper container. As explained above, the base of the lower side clamp may have a horizontal width exceeding e.g. 51 mm, or 54 mm to provide some margin, whereas the base of the upper side clamp may have a width of less than 51 mm, or less than 48 mm to provide some additional safety margin. According to a particularly simple configuration, the upper and lower side clamps may be rigidly connected to a common shaft for simultaneous operation, and the respective horizontal base widths of the side clamps may differ in the above described aspect as measured along a vertical plane comprising the shaft axis and intersecting the side clamps.

According to an embodiment, said indicator may be operably connected to a control system of the spreader, said control system being configured to generate an electronic indication signal to a truck carrying the spreader. Thereby, an operator of the truck may be notified via e.g. the truck's control system, and/or the truck may be configured to automatically limit the truck's maximum speed and/or prevent a lifting operation to be commenced. In the case of a mechanical indicator, such as a male lock insert shaped to allow engagement with only the upper corner casting of the lower container, the mechanical indicator may be provided with an electronic position sensor configured to provide said indication signal to the control system.

According to an embodiment, said first container locking arrangement may further comprise a lifting hook for connecting to a longitudinal side lock opening of the top corner casting of the lower container. A lifting hook may be rigidly connected to the spreader head, and may engage with the corner casting at the very abutment face of the spreader head. It may typically carry a higher vertical load than a pivotal side clamp. In such a configuration, the upper and lower side clamps would primarily serve for holding the two containers together, while the lifting hook would carry a majority of the vertical load of both containers when lifting. Typically, the lifting hook may be provided with a barb extending upwards to engage with the upper, inner edge of the lock opening.

According to an embodiment, the first container locking arrangement may further comprise a distance sensor configured to detect a distance between the corner casting of the lower container and a corner casting abutment face of the first container locking arrangement. The distance sensor may be configured to detect at least three different states, wherein a first state corresponds to the abutment face of the container locking arrangement being sufficiently close to the corner casting to allow the lifting hook to freely engage with an inner edge of the longitudinal side lock opening; a second state corresponds to the distance between the corner casting of the lower container and the corner casting abutment face being shorter than a predetermined distance, but too long to warrant that the lifting hook can freely engage with an inner edge of the longitudinal side lock opening; and a third state corresponds to no corner casting being detected. The distance sensor may comprise a movable indicator body configured to abut the corner casting, wherein said third state corresponds to the movable indicator body being out of contact with the corner casting.

According to an embodiment, the first container locking arrangement may further comprise a presence sensor configured to sense, when the container locking arrangement has been connected to the upper corner casting of the lower container, the presence of the lower corner casting of the upper container. Such a sensor adds an extra level of safety, and may be configured to generate a signal indicating whether the upper container is correctly positioned for lifting. The presence sensor may comprise a movable indicator body configured to abut an outer, vertical surface of the corner casting.

According to an embodiment, the side lift spreader may further comprise a second container locking arrangement arranged at a second longitudinal end of the spreader, the second container locking arrangement being configured in accordance with the first container locking arrangement as defined above. Having a container locking arrangement as described above at each end of the spreader even further reduces the risk of damaging or dropping a container.

According to another aspect of the invention, parts or all of the above mentioned problems are solved, or at least mitigated, by a method of lifting an upper intermodal transport container and a lower intermodal transport container in a single lifting operation, the method comprising attempting insertion of a male lock insert into one of a top corner casting of the lower container and a bottom corner casting of the upper container; based on said attempt, determining whether said one of a top corner casting of the lower container and a bottom corner casting of the upper container is the top corner casting of the lower container or the bottom corner casting of the upper container. Such a method reduces the risk of accidents as described above.

According to an embodiment, said determination may be based on said male lock insert being geometrically shaped to allow insertion into the top corner casting of the lower container, and to prevent insertion into the bottom corner casting of the upper container. Said male lock insert may be configured to be inserted into a gable lock opening of the top corner casting of the lower container, wherein said male lock insert has a horizontal width exceeding the horizontal width of a gable lock opening of the bottom corner casting of the upper container.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a schematic illustration in perspective of an intermodal container;

FIG. 2 is a schematic illustration in perspective of a top corner casting of the intermodal container of FIG. 1;

FIG. 3 is a schematic illustration in perspective of a bottom corner casting of the intermodal container of FIG. 1;

FIG. 4 is a diagrammatic view in perspective of a side lift spreader for handling intermodal containers;

FIG. 5 is a schematic side view of a lifting truck provided with the spreader of FIG. 4 carrying a pair of containers of the type illustrated in FIG. 1;

FIG. 6 is a schematic view in perspective of a portion of the spreader of FIG. 4;

FIG. 7 is a schematic view in perspective of a vertical carrier beam of the spreader of FIG. 4;

FIG. 8a is a diagrammatic view in perspective of a container locking arrangement of the vertical carrier beam of FIG. 7, illustrated with housing parts broken away, and as seen from a first perspective;

FIG. 8b is a diagrammatic view in perspective of the container locking arrangement of FIG. 8a, again illustrated with housing parts broken away, and as seen from a second perspective;

FIG. 9a is a schematic side view of the container locking arrangement of FIGS. 8a-b prior to connecting to a pair of containers;

FIG. 9b is a schematic side view of the container locking arrangement of FIG. 9a after connecting to the pair of containers;

FIG. 9c is a schematic side view of the container locking arrangement of FIG. 9a after connecting to only an upper container of said pair of containers;

FIG. 10 is a schematic view in perspective of a side clamp assembly;

FIG. 11 is a schematic illustration of the contour of an upper side clamp plate of the side clamp assembly of FIG. 10;

FIG. 12 is a schematic illustration of the contour of a lower side clamp plate of the side clamp assembly of FIG. 10;

FIG. 13a is a schematic illustration in perspective of the side clamp assembly of FIG. 10 prior to connecting to a pair of corner castings of the pair of containers of FIG. 5;

FIG. 13b is a schematic illustration in perspective of the side clamp assembly of FIG. 10 after connecting to the pair of corner castings of the pair of containers of FIG. 5; and

FIG. 14 is a schematic illustration of the contour of the lower side clamp plate of FIG. 11 on top of the contour of the upper side clamp plate of the side clamp assembly of FIG. 10.

### DETAILED DESCRIPTION OF THE EXEMPLARY EMBODIMENTS

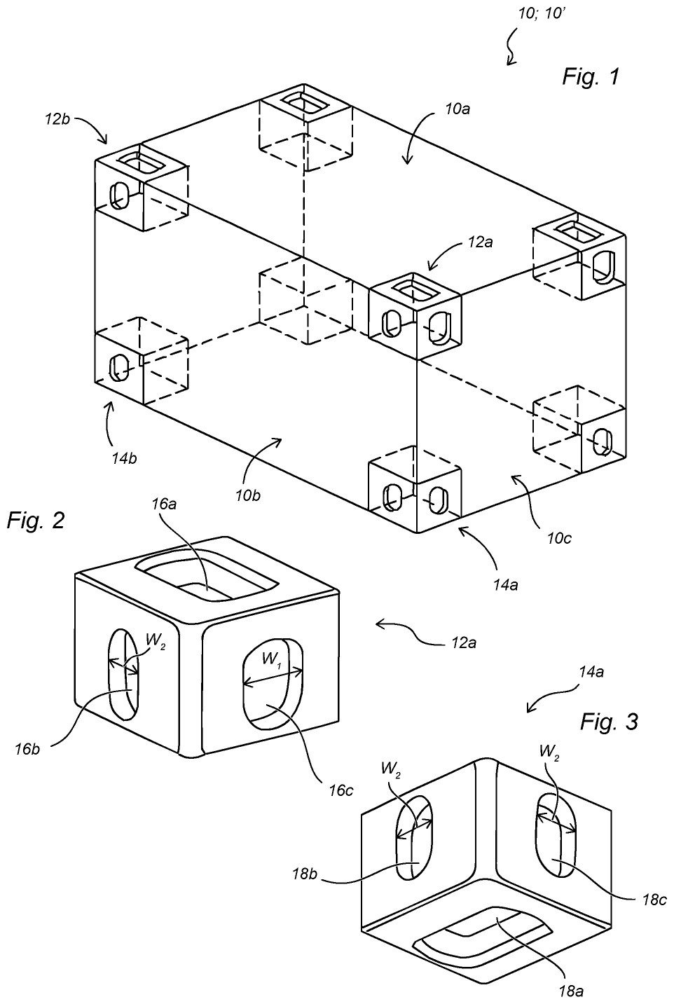

FIG. 1 schematically illustrates an intermodal container 10 according to the above-mentioned ISO standards. The container 10, which for clarity is illustrated transparent, has a top face 10a, a first longitudinal side 10b, and a first short side or gable side 10c. The container also has a bottom face, a second longitudinal side, and a second gable side, which are located opposite the top face, first longitudinal side, and first gable side, respectively. Each corner of the container 10 is provided with a respective corner casting for attaching a respective container locking arrangement, for the purpose of facilitating the handling of the container 10, and for locking the container 10 to other containers or to the deck of a freight ship. Hence, the container top corners which define the top corners of the first longitudinal side 10b are provided with a first top corner casting 12a and a second top corner casting 12b. Similarly, the container bottom corners which define the bottom corners of the first longitudinal side 10b are provided with a first bottom corner casting 14a and a second bottom corner casting 14b.

FIG. 2 illustrates the top corner casting 12a in greater detail, in the same perspective as in FIG. 1. It is provided with a top face lock opening 16a, a longitudinal side lock opening 16b, and a gable lock opening 16c, each of which is configured to receive and engage with a male insert of a container locking arrangement, such as a lifting hook or a twist-lock. As illustrated in FIG. 2, the gable lock opening 16c has a horizontal width W₁ exceeding the horizontal width W₂ of the longitudinal side lock opening 16b. This is because the gable lock openings 16c, according to the standard, were originally intended for lifting hooks dimensioned for lifting laden containers, which for reasons of strength are typically wider than e.g. a twist-lock. The top face lock opening 16a has the same width as the gable lock opening 16c, such that a lifting hook can enter the top face lock opening 16a and engage with the upper edge of the gable lock opening 16c from the inside. As the height/width ratio of the gable lock opening 16c is relatively moderate compared to the height/width ratio of the longitudinal side lock opening 16b, it is also less suitable for twist-locks compared to the longitudinal side lock opening 16b.

FIG. 3 illustrates the bottom corner casting 14a in greater detail, and as seen obliquely from below. It is provided with a bottom face lock opening 18a, a longitudinal side lock opening 18b, and a gable lock opening 18c, each of which is configured to receive and engage with a male insert of a container locking arrangement, such as a twist-lock. As illustrated in FIG. 3, the longitudinal side lock opening 18b and the gable lock opening 18c each have the same horizontal width W₂ as the longitudinal side lock opening 16b of the top corner casting 12a (FIG. 2).

Referring back to FIG. 1, a side lift spreader is a container handling device configured for handling empty containers 10 by connecting container locking arrangements, such as lifting hooks or twist locks, only at corner castings arranged at a single longitudinal side 10b of the container. For example, a single-container side lift spreader generally attaches to the top corner castings 12a, 12b of a single longitudinal side 10b. As each corner casting may be accessible from three different directions, it is however not necessary that the container locking arrangements access the corner castings 12a, 12b from the longitudinal side. It is possible that the container locking arrangements access the two corner castings 12a, 12b, arranged at the same longitudinal side 10b of the container, from above or from the gables 10c of the container 10. In other words, even though a side lift spreader approaches the container 10 from the longitudinal side 10b of the container 10 it is possible that the container locking arrangements of the side lift spreader access the corner castings 12a, 12b from another direction, i.e. from the gables 10c of the container 10 or from above. Thus, a side lift spreader may handle a container 10 by connecting container locking arrangements to e.g. two top corner castings 12a, 12b of the container, wherein the remaining two top corner castings of the container are not used by the side lift spreader for handling the container 10. In this sense a side lift spreader is clearly different from a top-lift spreader that handles a container 10 by connecting container locking arrangements to all four upper corner castings of the container. Such top-lift spreaders are needed for lifting laden containers, which are much heavier than empty containers.

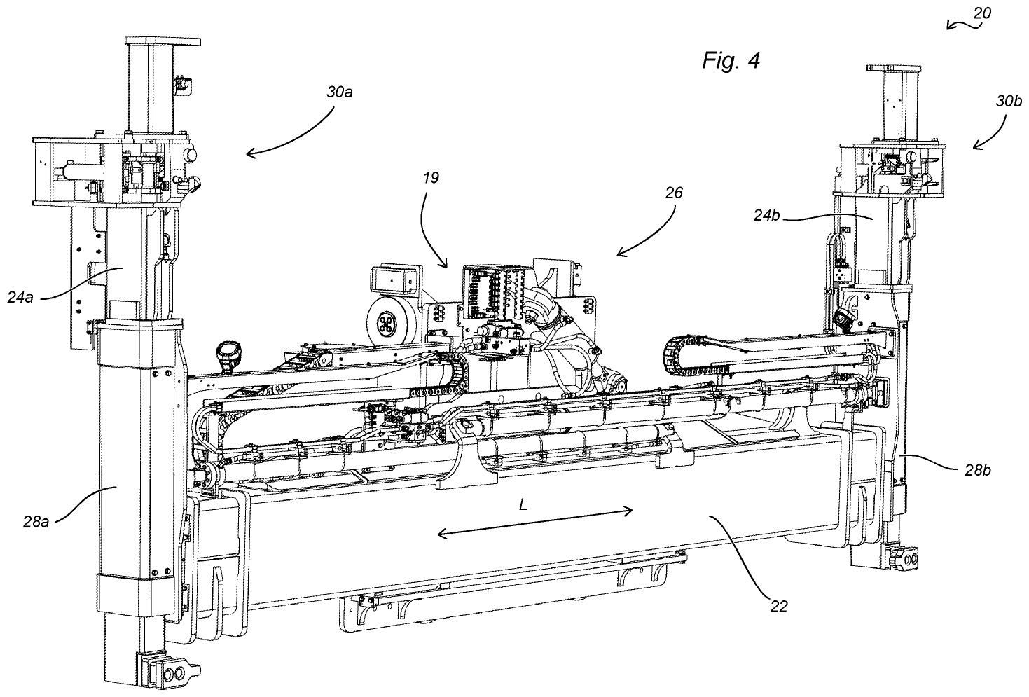

FIG. 4 illustrates a side-lift spreader 20 for handling two mutually stacked intermodal containers according to the above-mentioned ISO standards. The spreader 20 comprises a horizontal main beam 22, which supports a pair of vertical carrier beams 24a-b at respective ends thereof. The vertical carrier beams 24a-b are telescopically connected to the main beam 22 via respective travelling beams (not illustrated), which are configured to telescopically extend from the respective ends of the main beam 22 along the longitudinal axis L of the main beam 22. Thereby, the horizontal distance between the vertical carrier beams 24a-b can be varied to allow lifting containers of different lengths. A truck mast coupling 26 is mounted centrally on the main beam 22, and is configured to be connected to the mast of a lifting truck (not illustrated). Each vertical carrier beam 24a, 24b is vertically guided in a respective vertical sleeve 28a, 28b, which is welded to a distal end of the respective travelling beam (not illustrated). Adjacent to its top, each vertical carrier beam 24a-b is provided with a respective container locking arrangement 30a, 30b for connecting to corner castings in a manner that will be elucidated in detail further below. The container locking arrangements 30a, 30b are sometimes also referred to as spreader heads. A spreader controller 19 is operably connected to various sensors and actuators of the spreader 20 in a non-illustrated manner.

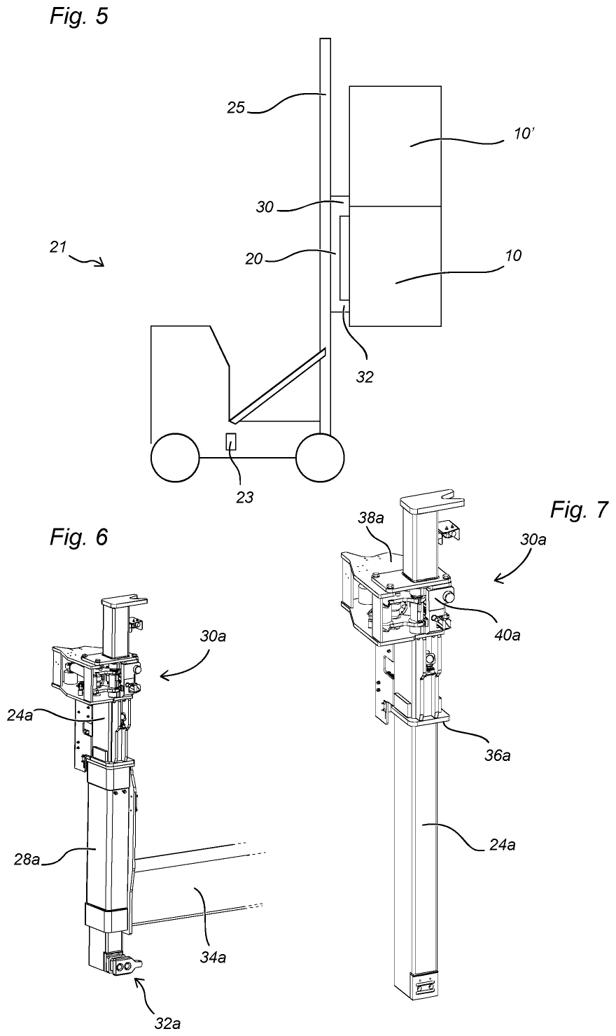

FIG. 5 schematically illustrates the spreader 20 of FIG. 4 connected to a lifting truck 21. The spreader 20 is vertically movable along a mast 25 to allow e.g. arranging of containers in high stacks. In the illustration of FIG. 5, the spreader 20 is connected to, and lifts, a pair of containers 10 and 10′. The lower container 10 is attached to the container locking arrangements 30 at its top corner castings 12a, 12b (FIG. 1), and its longitudinal side 10b (FIG. 1) rests on a container side support 32. The upper container 10′ rests on the lower container 10, and its bottom corner castings 14a, 14b (FIG. 1) are attached to the container locking arrangements 30. A truck control system 23 is operably connected to the spreader control system 19 (FIG. 4) in a non-illustrated manner, and allows communicating warnings from the spreader 20 to the driver of the truck 21.

FIG. 6 illustrates a first vertical carrier beam 24a of said pair of vertical carrier beams 24a-b, as carried by the vertical sleeve 28a. At its bottom end, the vertical carrier beam is provided with a container side support 32a which is configured to, once the container locking arrangement 30a has attached to the container 10 (FIG. 1), abut and support the longitudinal side 10 of the container 10. In the view of FIG. 5, the main beam has been removed for clarity of illustration, to reveal the travelling beam 34a welded to the vertical sleeve 28a.

FIG. 7 illustrates the first vertical carrier beam 24a as removed from the vertical sleeve 28a (FIG. 6). A horizontal flange 36a of the vertical carrier beam 24a is configured to rest upon the upper end of the vertical sleeve 28a; otherwise, the vertical carrier beam 24a is free to slide in the sleeve 28, in order to compensate for any differences in the horizontal alignment between the pair of container locking arrangements 30a-b (FIG. 4) and the container 10 to be lifted (FIG. 1) prior to connection. A housing 38a protects the container locking arrangement 30a from impacts, and a front face portion 40a of the housing is configured to abut the corner castings 12a, 14a at the longitudinal sides 10b of the containers 10 to be lifted.

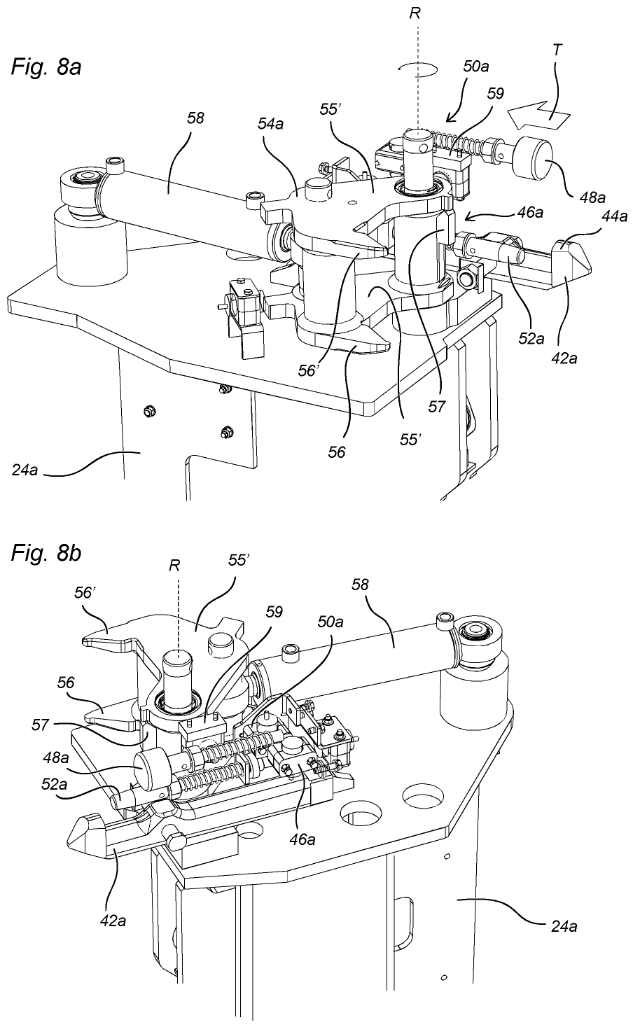

FIGS. 8a-b illustrate the first container locking arrangement 30a in detail, and with most of the housing 38a removed for clarity of illustration. The container locking arrangement 30a comprises a lifting hook 42a for connecting to the longitudinal side lock opening 16b (FIG. 1) of the top corner casting 12a of the lower container 10 (FIG. 1). The lifting hook 42a is rigidly attached to the spreader head, and is provided with a barb 44a extending upwards to engage with the upper, inner edge of the lock opening 16b.

An upper container presence sensor 46a has an indicator body 48a movable along a direction T transversal to the longitudinal direction L (FIG. 4), and is configured to detect the presence of the upper container 10′ when the indicator body 48a is pressed along the direction T by the bottom corner casting 14a (FIG. 3) of the upper container 10′ (FIG. 5).

A lower container distance sensor 50a comprises an indicator body 52a configured to be pressed along the direction T by the top corner casting 12a (FIG. 2) of the lower container 10 (FIG. 5), and thereby detect whether the abutment face 40a (FIG. 7) of the container locking arrangement 30a is sufficiently close to the corner casting 12a to allow the barb 44a to freely engage with the inner edge of the longitudinal side lock opening 16b (FIG. 2). Once the containers 10, 10′ are lifted, the detected distance between the corner casting 12a and the abutment face 40a of the container locking arrangement 30a also serves as an indicator of whether the lifting hook 42a remains properly engaged with the longitudinal side opening 16b.

A side clamp assembly 54a comprises a lower side clamp plate 55, defining a claw-shaped lower side clamp 56, and an upper side clamp plate 55′, defining a claw-shaped upper side clamp 56′. The side clamp assembly 54a is pivotally connected to the vertical carrier beam 24a to pivot about a vertical axis R between an inner position, which is illustrated in FIGS. 8a-b, and an outer position, in which the lower side clamp 56 engages with the gable lock opening 16c of the top corner casting 12a of the lower container 10 (FIG. 5), and the upper side clamp 56′ engages with the gable lock opening 18c of the bottom corner casting 14a of the upper container 10′. A hydraulic cylinder 58 has one end pivotally attached to the vertical carrier beam 24a, and the other end pivotally attached to the side clamp assembly 54a, to move the side clamp assembly 54a between the inner and outer positions. An indicator body 57 is configured to rotate with the side clamp assembly 54a, and when the side clamp assembly 54a is in the outer position, interact with an inductive sensor 59 to generate a side clamp insertion confirmation signal. The sensors 46a, 50a, and 59 are operably connected to the spreader control system 19 (FIG. 4) and the truck control system 23 (FIG. 5).

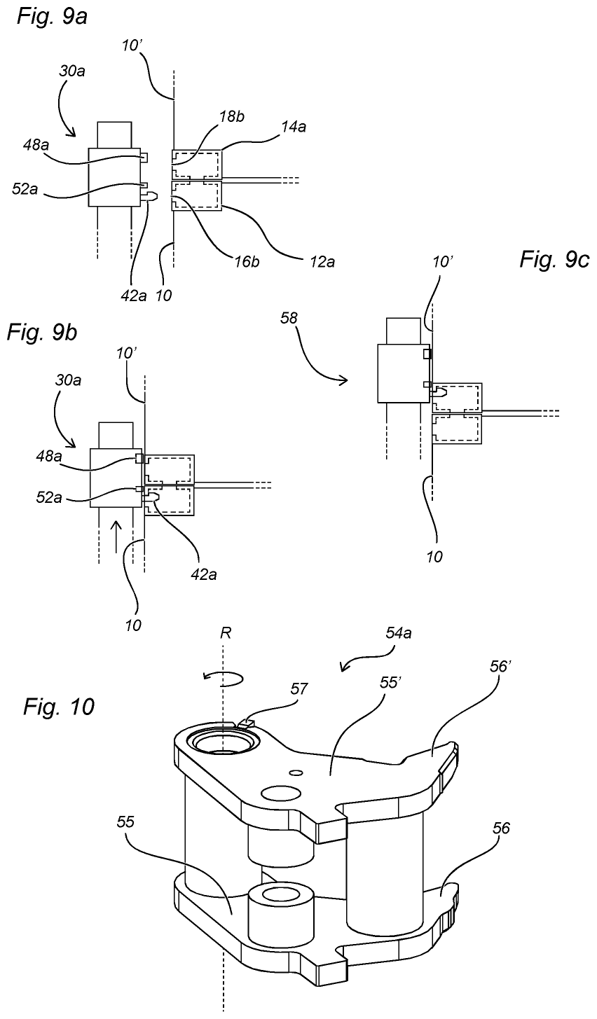

FIGS. 9a-b schematically illustrate the engagement between the lifting hook 42a and the lower container 10. From an initial position illustrated in FIG. 9a, the spreader is moved forward, such that the lifting hook 42a is inserted into the longitudinal side lock opening 16b of the top corner casting 12a of the lower container 10. Going from the position of FIG. 9a to the position of FIG. 9b, the indicator body 48a of the upper container presence sensor 46a will be pressed into the spreader head housing 38a (FIG. 7), thereby indicating to the control system 19 (FIG. 4) of the spreader 20 that the spreader 20 is simultaneously engaging with two containers 10, 10′. At the same time, the indicator body 52a of the distance sensor 50a will be pressed into the spreader head housing 38a, thereby indicating to the control system 19 of the spreader 20 that the lifting hook 42a has been sufficiently inserted to engage with the inner upper edge of the longitudinal side lock opening 16b of the upper corner casting 12a of the lower container 10. After having inserted the side clamps 56′, 56 (FIGS. 8a-b) into the respective gable lock openings 16c, 18c and received confirmation signals from the lower container distance sensor 50a and the side clamp position sensor 59, the spreader allows lifting the containers 10, 10′ in the direction of the arrow in FIG. 9b.

FIG. 9c illustrates a potentially dangerous situation which may occur if the spreader 20 is not level with the containers 10, 10′ to be lifted. In such a situation, one of the container locking arrangements, such as the container locking arrangement 30b of FIG. 4, may correctly engage with the lower container 10 in the manner illustrated in FIG. 9b, whereas the other container locking arrangement 30a may incorrectly engage with the upper container 10′ in the manner illustrated in FIG. 9c. If the gable side 10c (FIG. 1) of the upper container 10′ is shaped to allow the upper side clamp 56′ to be fully moved to the outer position, the spreader 20 may generate false confirmation signals permitting a lift. As one of the container locking arrangements 30b (FIG. 4) will lift both the containers 10, 10′, and the other container locking arrangement 30a will lift only the upper container 10′, the containers 10, 10′ may be damaged, and in the worst case, dropped to the ground. However, the side clamp assembly 54a is shaped to reduce the risk of arriving at such a situation.

FIG. 10 illustrates the side clamp assembly 54a in isolation, such that the lower and upper side clamp plates 55, 55′ are clearly visible.

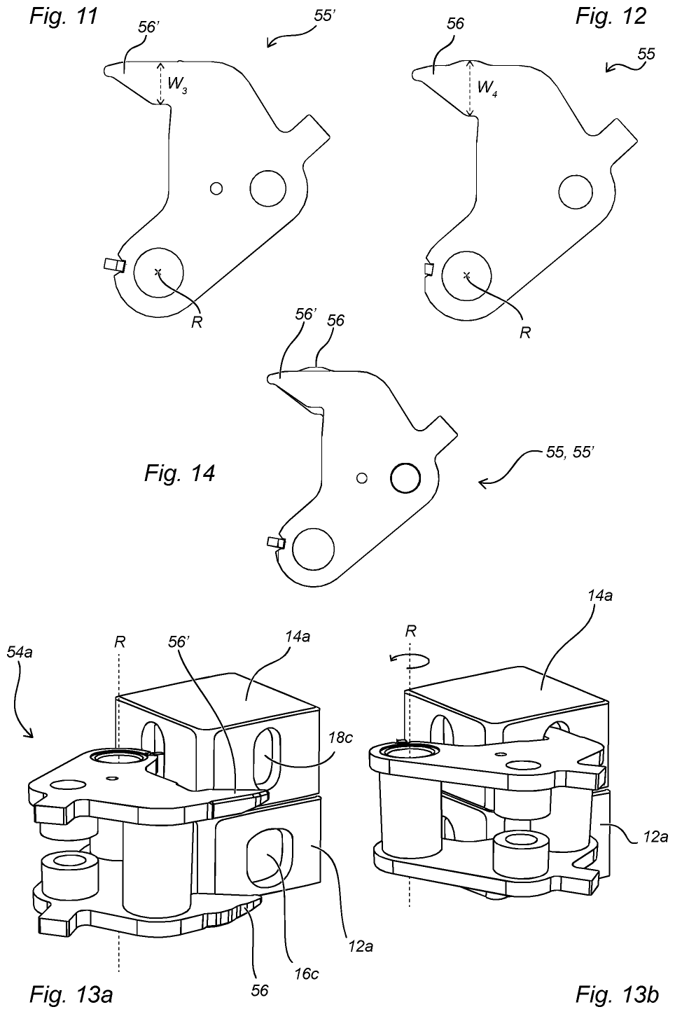

FIG. 11 illustrates the outer contours of the upper side clamp plate 55′. The upper side clamp 56′ has a horizontal width W₃, as measured in a radial direction with respect to the axis R of rotation. The horizontal width W₃ is inferior to the horizontal width W₂ of the lower gable lock opening 18c (FIG. 3) of the upper container 10′ (FIG. 5), thereby allowing the upper side clamp 56′ to be fully inserted into the lower gable lock opening 18c.

FIG. 12 illustrates the outer contours of the lower side clamp plate 55. The lower side clamp 56 has a horizontal width W₄, as measured in a radial direction with respect to the axis R of rotation, which is inferior to the horizontal width W₁ of the upper gable lock opening 16c (FIG. 2) of the lower container 10 (FIG. 5), thereby allowing the side clamp 56 to be fully inserted into the upper gable lock opening 16c.

FIGS. 13a-b illustrate the insertion of the side clamps 56′, 56 into the upper corner casting 12a of the lower container 10 (FIG. 5) and the lower corner casting 14a of the upper container 10′ (FIG. 5). FIG. 13a illustrates the side clamp assembly 54a in the inner, retracted position of FIGS. 7-8, whereas FIG. 13b illustrates the side clamp assembly 54a in the outer position. As the upper side clamp 56′ is fully insertable in the lower gable lock opening 18c of the upper container 10′, and the lower side clamp 56 is fully insertable in the upper gable lock opening 16c of the lower container 10, the side clamp assembly 54a can engage with both containers 10, 10′ when the container locking arrangement 30a is in the position illustrated in FIG. 9a.

Now referring back to FIG. 12, the horizontal width W₄ of the lower side clamp 56 is wider than the horizontal width W₂ of the lower gable lock opening 18c (FIG. 3) of the upper container 10′ (FIG. 5), which prevents the lower side clamp 56 to be fully inserted into the lower gable lock opening 18c of the upper container. Thereby, when attempting to connect the container locking arrangement 30a in the manner illustrated in FIG. 9b, the side clamp assembly 54a will be mechanically blocked from fully moving to the outer position, and the side clamp position sensor 59 (FIGS. 8a-b) will not generate any side clamp insertion confirmation signal.

According to the above mentioned ISO standards, W₁ should be about 63.5 mm, and W₂ should be about 51 mm; hence, W₃ should be less than about 51 mm, whereas W₄ should be between about 51 mm and about 63.5 mm. W₄ may preferably exceed 54 mm to provide some safety margin.

FIG. 14 illustrates the contours of the side clamp plates 55, 55′ when placed on top of each other. The illustration clearly shows a wider portion of the lower side clamp 56, which allows insertion into the wider, upper gable lock opening 16c (FIG. 2) of an ISO container 10 (FIG. 1).

Hereinbefore, the first container locking arrangement 30a (FIG. 4) has been described in detail. It will be appreciated that the second container locking arrangement 30b may be configured in a substantially identical manner for connecting to the corner castings 12b, 14b (FIG. 1) of the containers 10, 10′ (FIG. 5).

The concepts herein have mainly been described above with reference to a few embodiments. However, as is readily appreciated by a person skilled in the art, other embodiments than the ones disclosed above are equally possible within the scope of the invention, as defined by the appended patent claims.

For example, the lower side clamp 56 need not be shaped to prevent insertion into the lower gable lock opening 18c of the upper container 10′. As an exemplary though less preferred alternative, the spreader head may be provided with a camera and image processing circuitry configured to detect whether a gable lock opening 18c is present in front of the upper side clamp 56′, and of not, generate an error signal.

1-13. (canceled)

14. A side lift spreader for lifting an upper intermodal transport container and a lower intermodal transport container in a lifting operation, said upper and lower containers being stacked on each other, the spreader comprising:
a first container locking arrangement arranged at a first longitudinal end of the spreader, the first container locking arrangement comprising an upper male lock insert configured to be connected to a bottom corner casting of the upper container and a lower male lock insert configured to be connected to a top corner casting of the lower container, wherein said first container locking arrangement comprises an indicator configured to provide an indication whether an attempt is made to connect the lower male lock insert to the bottom corner casting of the upper container.

15. The side lift spreader of claim 14, wherein said indicator comprises a portion of the lower male lock insert geometrically shaped to prevent insertion of the lower male lock insert into the bottom corner casting of the upper container.

16. The side lift spreader of claim 15, wherein said lower male lock insert is adapted to be inserted into a gable lock opening of the top corner casting of the lower container, wherein said lower male lock insert has a first horizontal width exceeding a second horizontal width of a gable lock opening of the bottom corner casting of the upper container.

17. The side lift spreader according to claim 14, wherein said lower male lock insert is configured as a lower side clamp pivotal about a substantially vertical axis.

18. The side lift spreader according to claim 17, wherein the upper male lock insert is configured as an upper side clamp pivotal about said substantially vertical axis.

19. The side lift spreader according to claim 14, wherein said indicator is operably connected to a control system of the spreader, said control system being configured to generate an electronic indication signal to a truck carrying the spreader.

20. The side lift spreader according to claim 14, wherein said first container locking arrangement further comprises a lifting hook for connecting to a longitudinal side lock opening of the top corner casting of the lower container.

21. The side lift spreader according to claim 14, wherein the first container locking arrangement further comprises a distance sensor configured to detect a distance between the top corner casting of the lower container and a corner casting abutment face of the first container locking arrangement.

22. The side lift spreader according to claim 14, wherein the first container locking arrangement further comprises a presence sensor configured to sense, when the first container locking arrangement has been connected to the top corner casting of the lower container, a presence of the bottom corner casting of the upper container.

23. The side lift spreader according to claim 14, further comprising a second container locking arrangement arranged at a second longitudinal end of the spreader, the second container locking arrangement being configured in accordance with the first container locking arrangement.

24. A method of lifting an upper intermodal transport container and a lower intermodal transport container in a lifting operation, the method comprising:
attempting to insert a male lock insert into one of a top corner casting of the lower container and a bottom corner casting of the upper container; and
based on said attempt, determining whether said one of the top corner casting of the lower container and the bottom corner casting of the upper container is the top corner casting of the lower container or the bottom corner casting of the upper container.

25. The method according to claim 24, wherein said determination is based on said male lock insert being geometrically shaped to allow insertion into the top corner casting of the lower container, and to prevent insertion into the bottom corner casting of the upper container.

26. The method according to claim 25, wherein said male lock insert is configured to be inserted into a gable lock opening of the top corner casting of the lower container, said male lock insert having a first horizontal width exceeding a second horizontal width of a gable lock opening of the bottom corner casting of the upper container.

27. The method according to claim 24, wherein the method further comprises:
indicating whether the attempt is made to insert the male lock insert to the bottom corner casting of the upper container.

28. The method according to claim 24, wherein the method further comprises:
based on said determination, generating an electronic indication signal to a truck lifting the upper and lower intermodal transport containers.

29. The method according to claim 24, wherein the method further comprises:
sensing, when the male lock insert has been inserted into the top corner casting of the lower container, a presence of the bottom corner casting of the upper container.

30. A lifting arrangement of an upper intermodal transport container and a lower intermodal transport container comprising:
a lifting truck provided with a mast;
a truck mast coupling mounted on a main beam of a side lift spreader, the truck mast coupling configured to be connected to the mast of the lifting truck; and
the side lift spreader for lifting the upper intermodal transport container and the lower intermodal transport container, said upper and lower containers being stacked on each other, the spreader comprising:
a first container locking arrangement arranged at a first longitudinal end of the spreader, the first container locking arrangement comprising an upper male lock insert configured to be connected to a bottom corner casting of the upper container and a lower male lock insert configured to be connected to a top corner casting of the lower container, wherein said first container locking arrangement comprises an indicator configured to provide an indication whether an attempt is made to connect the lower male lock insert to the bottom corner casting of the upper container.

31. The lifting arrangement according to claim 30, wherein said indicator comprises a portion of the lower male lock insert geometrically shaped to prevent insertion of the lower male lock insert into the bottom corner casting of the upper container.

32. The lifting arrangement according to claim 31, wherein said lower male lock insert is adapted to be inserted into a gable lock opening of the top corner casting of the lower container, wherein said lower male lock insert has a first horizontal width exceeding a second horizontal width of a gable lock opening of the bottom corner casting of the upper container.

33. The lifting arrangement according to claim 30, wherein said indicator is operably connected to a control system of the spreader, said control system being configured to generate an electronic indication signal to the lifting truck carrying the spreader.
